(19) United States
(12) Patent Application Publication
(10) Pub. No.: US 2026/0041275 A1
(43) Pub. Date: Feb. 12, 2026

(54) CHARCOAL BARBECUE GRILL CAPABLE OF ADJUSTING THE HEATING TEMPERATURE

(71) Applicant: Supply Chain Sources LLC, Allen, TX (US)

(72) Inventors: Binglu Song, Allen, TX (US); Yonghui Chen, Allen, TX (US)

(21) Appl. No.: 19/291,502

(22) Filed: Aug. 5, 2025

(30) Foreign Application Priority Data
Aug. 6, 2024 (CN) 202421886757.0

(51) Int. Cl. A47J 37/07

(52) U.S. Cl. CPC A47J 37/0709; A47J 37/079

(57) ABSTRACT

Provided herein are charcoal grills capable of precisely adjusting a heating temperature, the grill having a furnace body, a grilling grate, and a charcoal box, wherein the grilling grate and the charcoal box are installed inside the furnace body, the charcoal box having a charcoal box body, a charcoal box cover, and a charcoal mesh, wherein the charcoal box cover is mounted onto the box body, the charcoal box cover is rotatably connected to the charcoal box body, and the charcoal mesh is fixedly installed inside the charcoal box body.

### CROSS-REFERENCE TO RELATED APPLICATIONS

This application claims the benefit of Chinese Patent Application No. 202421886757, filed Aug. 6, 2024, which is hereby incorporated by reference, to the extent that it is not conflicting with the present application.

### BACKGROUND OF INVENTION

### 1. Field of the Invention

The invention relates generally to barbecue tools, and more particularly to a charcoal barbecue oven capable of adjusting the heating temperature.

### 2. Description of the Related Art

As people pursue a better life, outdoor barbecue has become a very popular leisure activity, so small barbecue grills have also become a must-have for many families. Common barbecue grills include charcoal grills, electric grills and gas grills. Charcoal grills are a kind of barbecue equipment that uses charcoal as fuel. Due to its convenient operation, low fuel cost, food that is crispy outside and tender inside, with good flavor and many other advantages after grilling, it has become the first choice for many people who enjoy outdoor barbecue.

Traditional charcoal grills mostly use charcoal fire to bake food directly. During the baking process, the temperature may be too high or too low and cannot be controlled. If the temperature is too high, the charcoal cannot dissipate heat in time, which can easily cause the food to burn. If the temperature is too low, air needs to be introduced to help combustion to heat up the charcoal. In this way, it is difficult to find the most suitable temperature for baking. There are also some charcoal grills that can bake at a constant temperature to keep the grill at a constant temperature, so as to avoid burning food. However, the constant temperature charcoal grill uses an air supply fan to blow hot air from the charcoal bed onto the grill to heat the food. The charcoal fire is separated from the grill, and the temperature can only be adjusted by the air volume of the fan. It does not have the function of high-temperature baking, the grill heats up slowly, and the baking efficiency is low.

Additionally, some known or existing grills do not provide smart or remote WiFi control, which may be preferred by some users for convenience. In some cases which do provide smart or remote WiFi control, only single variable temperature control systems are provided, which may not offer high efficiency.

Therefore, there is a need for a solution to the above problems.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

Provided herein is a charcoal grill capable of precisely adjusting the heating temperature, the grill comprising a furnace body, a grilling or baking grate or mesh (“grilling grate”), and a charcoal box, wherein the grilling grate and the charcoal box are installed inside the furnace body, and the charcoal box comprises a charcoal box body, a charcoal box cover, and a charcoal mesh, wherein the charcoal box cover is mounted onto the charcoal box body, the charcoal box cover is rotatably connected to the charcoal box body, and the charcoal mesh is fixedly installed inside the charcoal box body.

The charcoal grill can open the charcoal box cover so that the charcoal fire can directly heat the grilling grate, and can close the charcoal box cover to use the diffusion of temperature to make the grilling grate temperature within a certain range, which can quickly heat up and control the temperature, can directly heat food with high-temperature charcoal fire, and can accurately control the temperature and heat food at a constant temperature, thereby improving the problems of slow heating and low baking efficiency of constant-temperature charcoal grills in the prior art, and achieving a better baking effect.

In view of the defects of the prior art, the technical problem to be solved by the utility model is that the charcoal fire and the grilling grate of the constant temperature charcoal grill are separated, and the temperature can only be adjusted by the air volume of the fan, and the function of high temperature baking is not available. The grill heats up slowly and the baking efficiency is low. In order to solve the above technical problems, the utility model proposes a charcoal grill that can adjust the heating temperature, and adopts the following technical solutions:

A charcoal grill that can adjust the heating temperature includes a furnace body, a grilling grate and a charcoal box, the grilling grate and the charcoal box are installed inside the furnace body, the charcoal box includes a charcoal box body, a charcoal box cover and a charcoal mesh, the charcoal box cover is mounted on the charcoal box body, the charcoal box cover is rotatably connected to the charcoal box body, and the charcoal mesh is fixedly installed inside the charcoal box body.

This structure is different from other charcoal grills that use open charcoal boxes to directly heat the grilling grate. The charcoal box of this charcoal grill is provided with a charcoal box cover, which is fixedly set under the grilling grate. When the charcoal box cover is opened, the charcoal fire can directly heat the grilling grate. When the furnace body interior reaches a suitable temperature, the charcoal box cover is closed, and the charcoal fire no longer directly heats the grilling grate but continues to heat the grilling grate by temperature diffusion. The charcoal grills disclosed herein are configured to monitor the heating temperature within the furnace body such that the charcoal box cover can be opened when the temperature falls below a predetermined target temperature or temperature range and can be closed when the temperature is above a predetermined target temperature or temperature range, for example. In this way, the temperature within the furnace body can be controlled within a certain range to prevent the furnace body interior from overheating and causing the food to burn.

Further, it also includes a rotating device, which includes a rotating rod and a rotating motor. The rotating motor is fixedly installed outside the furnace body, one end of the rotating rod passes through the furnace body and is fixedly connected to the rotating motor, and the other end of the rotating rod is rotatably connected to the charcoal box body. In an aspect, there are two rotating rods, and there are at least two charcoal box covers, and the two rotating rods are respectively fixedly connected. The rotating device controls the rotation and opening and closing of the charcoal box cover, thereby realizing the switching between high temperature and constant temperature heating methods during the baking process.

Furthermore, it also includes a combustion-supporting device, which includes a combustion-supporting fan and an air supply channel. The combustion-supporting fan is fixedly installed on the outside of the furnace body, one end of the air supply channel is connected to the air outlet of the combustion-supporting fan, and the other end of the air supply channel is connected to the inner wall of the furnace body. The air supply channel is fixedly set at the lower part of the charcoal box, and the top of the air supply channel is connected to the bottom of the charcoal box body. The combustion-supporting device is connected to the charcoal box to input external air into the charcoal box, which has a good combustion-supporting effect, and the charcoal fire burns more fully, heats up faster, and burns more efficiently.

Further, an electric heating wire is provided at the connection between the air supply channel and the charcoal box, and the electric heating wire is fixedly set below the charcoal mesh. Before using the charcoal grill, it is necessary to ignite the charcoal fire in the charcoal box. Ordinary charcoal grills need to ignite the ignition material first, and then use the ignition material to ignite the charcoal fire. The electric heating wire can quickly heat the charcoal mesh by energizing and heating it, so that its temperature reaches the ignition point of the charcoal fire so that the charcoal fire burns, thereby optimizing the ignition process and making the ignition method convenient and quick.

Furthermore, it also includes a constant temperature fan, which is fixedly installed on the outside of the furnace body, and an air supply port is provided on one side of the furnace body, and the constant temperature fan is fixedly connected to the air supply port. When the temperature inside the furnace body is too high, the constant temperature fan operates to send external air into the furnace body, which can cool the furnace body, thereby ensuring that the inside of the furnace body is always at a temperature suitable for baking.

Further, the furnace body includes a furnace box body and a furnace cover or lid (“furnace cover”), one side of the furnace cover is rotatably connected to the furnace box body, and the other side of the furnace cover is fixedly installed with a handle, and the furnace cover is also provided with an exhaust port. The furnace body is provided with a furnace cover, and when the furnace needs to heat up quickly or bake at a constant temperature, the furnace cover can be closed, and when the heating reaches a certain temperature, the furnace cover can be opened to observe the food while baking, thereby controlling the degree of baking.

Further, the furnace box body is also provided with a charcoal adding port, which is provided on the side wall of the furnace box body. The charcoal adding port reserved on the side wall can be used to directly add charcoal when the charcoal fire is insufficient without removing the grilling grate, which makes the charcoal grill more convenient to use. In such embodiments, charcoal can be easily manually added during use.

Further, an ash oil pan is provided at the bottom of the furnace box body, and the ash oil pan is slidably connected to the furnace box body. The ash oil pan is designed mainly to receive the grease dropped by cooking and the dust generated by the burning of charcoal fire, so that the ash oil pan can be pulled out and cleaned directly after the charcoal grill is used.

Further, it also includes a bracket, which is fixed to the bottom of the furnace body, and the bracket includes a frame body and a wheel, and the wheel is fixedly installed at the bottom of the frame body. The bracket with a wheel is provided to facilitate the movement of the charcoal grill.

Further, it also includes a shelf, which is fixedly installed on the outside of the furnace body. The partition shelf is provided to facilitate the placement of various items when using the charcoal grill.

In summary, this charcoal grill that can adjust the heating temperature can heat up quickly and control the temperature, can directly heat food with high-temperature charcoal fire, and can accurately control the temperature and heat food at a constant temperature, which improves the problem of slow heating and low baking efficiency of constant temperature charcoal grills in the prior art, and achieves a better baking effect.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 depicts a top perspective view of the internal structure of the furnace body of a charcoal grill, according to an aspect.

FIG. 2 depicts a top perspective view of the external structure of the charcoal box of a charcoal grill, according to an aspect.

FIG. 3 depicts a top view of the internal structure of the charcoal box of a charcoal grill, according to an aspect.

FIG. 4 depicts a partial perspective view of the charcoal grill, according to an aspect.

FIG. 5 depicts a side, perspective view of a fully assembled charcoal grill, according to an aspect.

FIG. 6 depicts a bottom, perspective view of a fully assembled charcoal grill, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

As used herein and throughout this disclosure, the term “mobile device” refers to any electronic device capable of communicating across a mobile network. A mobile device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories). A transceiver includes but is not limited to cellular, GPRS, Bluetooth, and Wi-Fi transceivers.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Mobile devices communicate with each other and with other elements via a network, for instance, a cellular network. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH.®. networks, with communication being enabled by transceivers. A network typically includes a plurality of elements such as servers that host logic for performing tasks on the network. Servers may be placed at several logical points on the network. Servers may further be in communication with databases and can enable communication devices to access the contents of a database. For instance, an authentication server hosts or is in communication with a database having authentication information for users of a mobile network. A “user account” may include several attributes for a particular user, including a unique identifier of the mobile device(s) owned by the user, relationships with other users, call data records, bank account information, etc. A billing server may host a user account for the user to which value is added or removed based on the user's usage of services. One of these services includes mobile payment. In exemplary mobile payment systems, a user account hosted at a billing server is debited or credited based upon transactions performed by a user using their mobile device as a payment method.

For the following description, it can be assumed that most correspondingly labeled elements across the figures possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

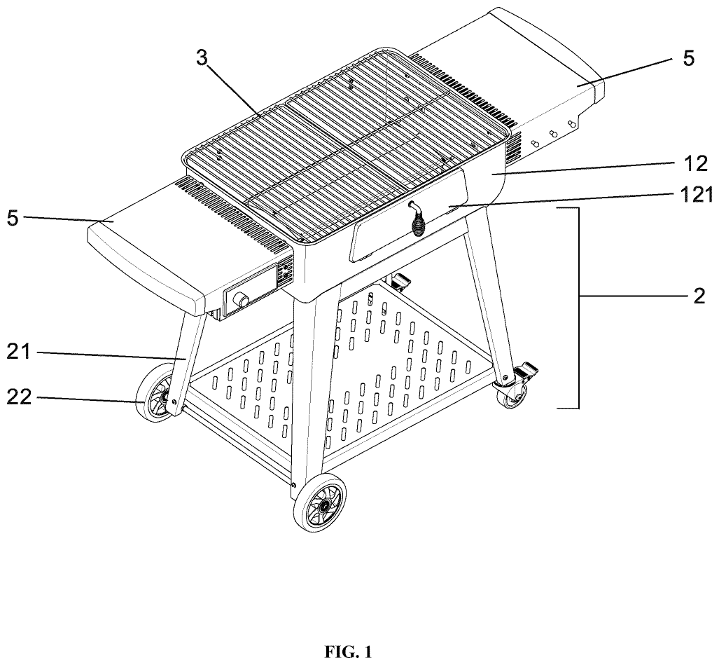

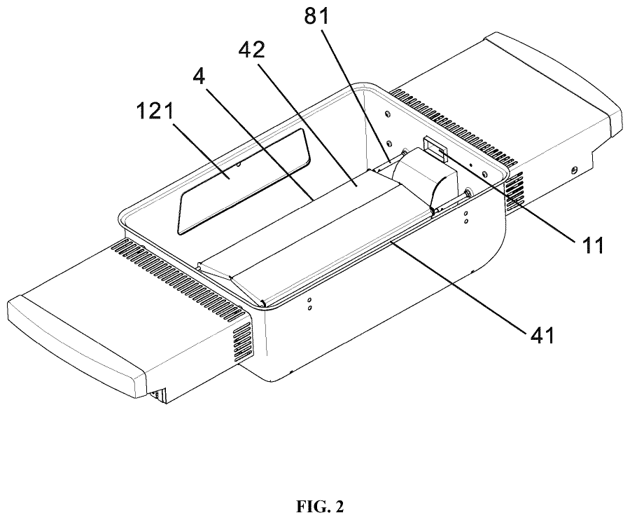

As shown in FIGS. 1-3, the charcoal grills disclosed herein may comprise the following components: furnace body—1, air supply port—11, furnace box body—12, charcoal adding port—121, ash oil tray—122, furnace cover—13, handle—131, exhaust port—132, bracket—2, frame—21, wheel—22, grilling grate—3, charcoal box—4, charcoal box body—41, charcoal box cover—42, charcoal mesh—43, partition shelf—5, combustion—supporting device—6, combustion—supporting fan—61, air supply channel—62, heating wire—7, rotating device—8, rotating rod—81, rotating motor—82, constant temperature fan—9.

Disclosed herein is a charcoal grill capable of adjusting the heating temperature, wherein the charcoal grill comprises a furnace body 1, a grilling grate 3, and a charcoal box 4, wherein the grilling grate 3 and the charcoal box 4 are installed inside the furnace body 1, and the charcoal box 4 comprises a charcoal box body 41, a charcoal box cover 42 and a charcoal mesh 43, wherein the charcoal box cover 42 is mounted on the charcoal box body 41, the charcoal box cover 42 is rotatably connected to the charcoal box body 41, and the charcoal mesh 43 is fixedly installed inside the charcoal box body 41.

With this structure, unlike other charcoal grills that use an open charcoal box and charcoal fire to directly heat the grilling grate, the charcoal box 4 of this charcoal grill is provided with a charcoal box cover 42, and the charcoal box 4 is fixedly arranged under the grilling grate 3. When the charcoal box covers 42 is opened, the charcoal fire can directly heat the grilling grate 3. A temperature sensor, which may be a Resistance Temperature Detector (RTD), monitors the temperature inside the furnace body 1, and when the interior of the furnace body 1 and the grilling grate 3 rises to a suitable temperature, the charcoal box cover 42 is closed, and the charcoal fire no longer directly heats the grilling grate 3 but continues to heat the grilling grate by temperature diffusion. In this way, the temperature of the grilling grate 3 can be controlled within a certain range to prevent the grilling grate 3 from overheating and causing the food to burn.

Generally, provided herein are charcoal grills capable of adjusting a heating temperature in the charcoal grill. In some embodiments, the charcoal grills comprise an added combustion fan, thermostat fan, opening and closing automatic control systems for the charcoal box cover, and a central controller.

Generally, charcoal grills can be challenging to control in terms of temperature. Accordingly, the charcoal grills disclosed herein are provided with built-in, precise temperature control systems that automatically adjust air vents or even add charcoal as needed, or allow for easy manual addition of charcoal by the user, to maintain consistent heat levels.

Charcoal grills can also be labor-intensive to clean. Accordingly, the charcoal grills disclosed herein are provided with improved ash management systems, such as easy-to-remove ashtrays, or self-cleaning mechanisms.

In contrast with gas grills, charcoal grills require manual ignition, which can be cumbersome. Accordingly, the charcoal grills disclosed herein are provided with an integrated, reliable, and quick ignition system.

As with pellet grills, some users appreciate technology that allows them to monitor and control their grill remotely using a mobile device, for example via a smartphone application, particularly for long cooking processes like smoking. Accordingly, the charcoal grills disclosed herein are provided with means for integration and association with mobile device applications and connectivity via wireless networks, including WiFi or Bluetooth.

In some embodiments, the charcoal ignited on the charcoal bed directly heats the food on the above grate. The unique multi-variable Proportional Integral Derivative (PID) precise temperature control software algorithm can be adopted and provided for the charcoal grills disclosed herein, such that the heating temperature is finely adjusted by the comprehensive use of the combustion fan, the thermostat fan, and the open/close control system of the cover of the charcoal bed.

In some embodiments, a comprehensive multi-variable PID precise temperature control intelligent algorithm and WiFi remote control system is provided for the charcoal grills disclosed herein. Compared with single variable control, comprehensive multi-variable temperature control can achieve a shorter time to reach a set or desired temperature, can provide a smaller range of temperature changes, and can provide more efficient or better energy saving.

In some embodiments, the charcoal grills disclosed herein can be provided with a mode for directly heating food with a high temperature charcoal fire with an accurately controlled temperature (such as, for example, around 220° F.-850° F), and a mode for heating food at a set temperature. In such embodiments, the charcoal grills can be provided with a means for freely switching between the two modes, such as by rotating a control knob.

In some embodiments, the charcoal grills disclosed herein can achieve a maximum temperature around a center area of the grate of approximately 850° F., in contrast to some known or common grills available which only reach a maximum temperature of approximately 650° F.

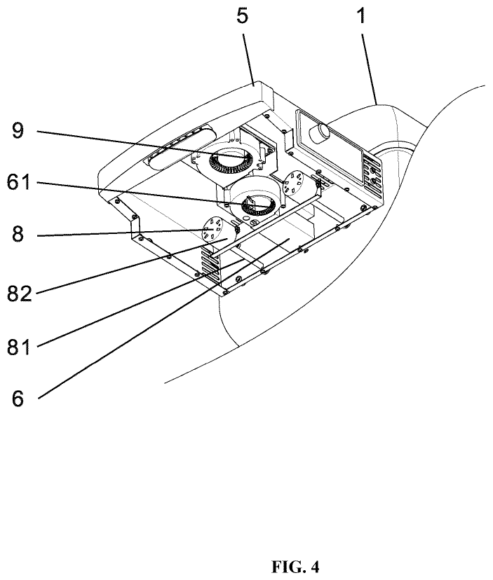

As shown in FIG. 4, a rotating device 8 is also included. The rotating device 8 includes at least one rotating rod 81 and at least one rotating motor 82. The rotating motor 82 is fixedly installed outside the furnace body 1. One end of the rotating rod 81 passes through the furnace body 1 and is fixedly connected to the rotating motor 82. The other end of the rotating rod 81 is rotatably connected to the charcoal box body 41. In an aspect, two rotating rods 81 and two rotating motors are provided, there are at least two charcoal box covers 42, and the two rotating rods 81 are respectively fixedly connected to the charcoal box covers 42. The rotating device 8 controls the rotation and opening and closing of the charcoal box cover 42, thereby realizing the switching between high temperature and constant temperature heating modes during the baking process.

As an embodiment, the charcoal box covers 42 can be fixedly provided in two pieces, and the rotating motor 82 drives the rotating rod 81 to rotate to control the opening and closing of the middle of the charcoal box cover 42.

Furthermore, as shown in FIG. 4, a combustion-supporting device 6 is also included, and the combustion-supporting device 6 includes a combustion-supporting fan 61 and an air supply channel 62. The combustion-supporting fan 61 is fixedly installed on the outside of the furnace body 1, one end of the air supply channel 62 is connected to the air outlet of the combustion-supporting fan 61, and the other end of the air supply channel 62 is connected to the inner wall of the furnace body 1. The air supply channel 62 is fixedly arranged at the lower part of the charcoal box 4, and the top of the air supply channel 62 is connected to the bottom of the charcoal box body 41. The combustion-supporting device 6 is connected to the charcoal box 4 to input external air into the charcoal box 4, which has a good combustion-supporting effect, and the charcoal fire burns more fully, heats up faster, and has a higher combustion efficiency.

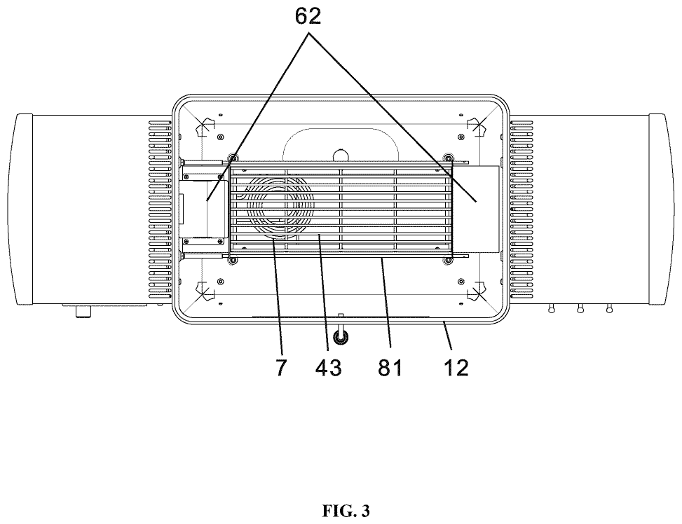

Further, as shown in FIG. 3, a heating wire 7 is provided at the connection between the air supply channel 62 and the charcoal box 4, and the heating wire 7 is fixedly provided below the charcoal mesh 43. Before using the charcoal grill, the charcoal fire in the charcoal box needs to be ignited. Ordinary charcoal grills need to first ignite the ignition material and then use the ignition material to ignite the charcoal fire. The heating wire 7 can quickly heat the charcoal mesh 43 by energizing and heating it, so that its temperature reaches the ignition point of the charcoal fire so that the charcoal fire burns, thereby optimizing the ignition process and making the ignition method convenient and quick.

In some embodiments, the charcoal grills disclosed herein are provided with automatic ignition. The charcoal can be automatically ignited by operating a control knob, without other ignition materials or operations.

Further, as shown in FIG. 4, it also includes a constant temperature fan 9, which is fixedly installed on the outside of the furnace body 1, and an air supply port 11 is provided on one side of the furnace body 1. The constant temperature fan 9 is fixedly connected to the air supply port 11. When the temperature inside the furnace body 1 is too high, the constant temperature fan 9 operates to send external air into the furnace body 1, which can cool the furnace body 1, thereby ensuring that the furnace body 1 is always at a temperature suitable for baking.

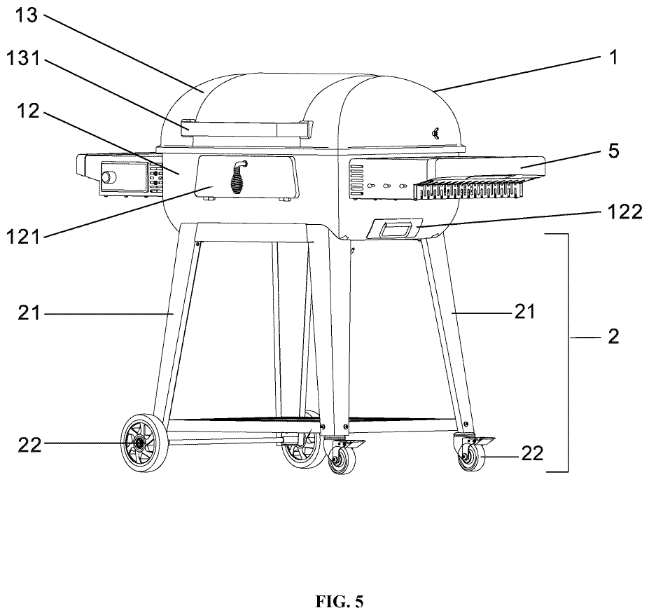

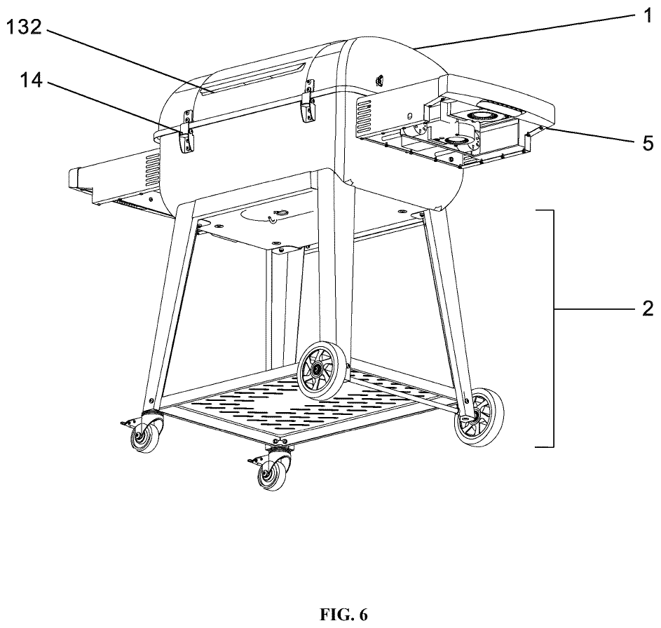

As shown in FIGS. 5-6, the furnace body 1 includes a furnace box body 12 and a furnace cover 13, one side of the furnace cover 13 is rotatably connected to the furnace box body 12 with hinges 14, and the other side of the furnace cover 13 is fixedly installed with a handle, and the furnace cover 13 is also provided with an exhaust port 132 for venting smoke. The furnace body 1 is provided with a furnace cover 13 rotatably connected to the furnace box body 12, and the furnace cover 13 can be closed when the furnace needs to heat up quickly or bake at a constant temperature. When the food is heated to a certain degree, the furnace cover 13 can be opened to observe while baking the food, thereby controlling the degree of baking.

Further, as shown in FIG. 5, the furnace box body 12 is also provided with a charcoal adding port 121, which is provided on the side wall of the furnace box body 12. The charcoal adding port 121 reserved on the side wall can be used to directly add charcoal when the charcoal fire is insufficient without removing the grilling grate 3, which makes the charcoal grill more convenient to use.

Further, as shown in FIG. 5, an ash oil pan 122 is provided at the bottom of the furnace box body 12, and the ash oil pan 122 is slidably connected to the furnace box body 12. The ash oil tray 122 is designed mainly to receive the grease dropped during cooking and the dust generated by the burning charcoal fire, so that the ash oil tray 122 can be pulled out and cleaned directly after the charcoal grill is used.

Further, as shown in FIGS. 5-6, a bracket 2 is also included, the bracket 2 is fixed at the bottom of the furnace body 1, the bracket 2 includes a frame 21 and a wheel 22, and the wheel 22 is fixedly installed at the bottom of the frame 21. The bracket 2 with the wheel 22 is provided to facilitate the movement of the charcoal grill.

Further, as shown in FIGS. 5-6, a shelf 5 is also included, and the shelf 5 is fixedly installed on the outside of the furnace body 1. The partition shelf 5 is provided to facilitate the placement of various items when using the charcoal grill.

In summary, this charcoal grill that can adjust the heating temperature can both heat up quickly and control the temperature, can directly heat food with high-temperature charcoal fire, and can accurately control the temperature and heat food at a constant temperature, which improves the problem of slow heating and low baking efficiency of the constant temperature charcoal grill in the prior art, and achieves a better baking effect.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A charcoal grill capable of adjusting a heating temperature, comprising:
a furnace body;
a grilling grate; and
a charcoal box, comprising a charcoal box body, at least one charcoal box cover, and a charcoal mesh;
wherein the grilling grate and the charcoal box are installed inside the furnace body;
wherein the at least one charcoal box cover is mounted onto the charcoal box body, the at least one charcoal box cover is rotatably connected to the charcoal box body, and the charcoal mesh is fixedly installed inside the charcoal box body.

2. The charcoal grill of claim 1, comprising a rotating device, the rotating device comprising at least one rotating rod and at least one rotating motor;
wherein the at least one rotating motor is fixedly installed outside the furnace body;
wherein a first end of the at least one rotating rod passes through the furnace body and is fixedly connected to the at least one rotating motor;
wherein a second end of the at least one rotating rod is rotatably connected to the charcoal box body; and
wherein the at least one rotating rod is provided on the at least one charcoal box cover and is fixedly connected to the at least one charcoal box cover.

3. The charcoal grill of claim 2, comprising a combustion-supporting device, the combustion-supporting device comprising:
a combustion-supporting fan; and
an air supply channel;
wherein the combustion-supporting fan is fixedly installed on an exterior of the furnace body;
wherein a first end of the air supply channel is connected to an inner wall of the furnace body;
wherein the air supply channel is fixedly arranged at a bottom of the charcoal box; and
wherein a top of the air supply channel is connected to a bottom of the charcoal box body.

4. The charcoal grill of claim 3, wherein an electric heating wire is arranged at a connection between the air supply channel and the charcoal box; and wherein the electric heating wire is fixedly arranged below the charcoal mesh.

5. The charcoal grill of claim 1, comprising a constant temperature fan fixedly installed on an exterior of the furnace body;
wherein a side of the furnace body is provided with an air supply port, and
wherein the constant temperature fan is fixedly connected to the air supply port.

6. The charcoal grill of claim 1, wherein the furnace body comprises a furnace box body and a furnace cover; wherein a first side of the furnace cover is rotatably connected to the furnace box body, and a second side of the furnace cover is fixedly provided with a handle; and wherein the furnace cover comprises an exhaust port.

7. The charcoal grill of claim 6, the furnace box body comprising a charcoal adding port;
wherein the charcoal adding port is provided on a side wall of the furnace box body.

8. The charcoal grill of claim 7, comprising an ash oil pan at a bottom of the furnace box body; wherein the ash oil pan is slidably connected to the furnace box body.

9. The charcoal grill of claim 1, comprising a bracket fixed to a bottom of the furnace body;
wherein the bracket comprises a frame; and a wheel; wherein the wheel is fixedly installed at a bottom of the frame.

10. The charcoal grill of claim 1, comprising a shelf fixedly installed on an exterior of the furnace body.

11. A charcoal grill capable of adjusting a heating temperature, comprising:
a furnace body;
a grilling grate; and
a charcoal box, comprising a charcoal box body, at least one charcoal box cover, and a charcoal mesh, wherein the charcoal box body is configured to hold a charcoal fire;
wherein the grilling grate and the charcoal box are installed inside the furnace body such that the grilling grate is positioned above the charcoal box;
wherein the at least one charcoal box cover is mounted onto the charcoal box body, the at least one charcoal box cover is rotatably connected to the charcoal box body, and the charcoal mesh is fixedly installed inside the charcoal box body;
wherein the at least one charcoal box cover is configured to be in an open state or a closed state;
wherein the open state of the at least one charcoal box cover allows for the charcoal fire to directly heat the grilling grate;
wherein the charcoal grill is configured to monitor the heating temperature and close the at least one charcoal box cover when the heating temperature reaches or exceeds a predetermined target temperature.

12. The charcoal grill of claim 11, wherein the charcoal grill is configured to monitor the heating temperature and open the at least one charcoal box cover when the heating temperature falls below the predetermined target temperature.

13. The charcoal grill of claim 11, comprising an automatic ignition system operable by a control knob.

14. The charcoal grill of claim 11, comprising a constant temperature fan fixedly connected to an air supply port on a side of the furnace body; wherein the constant temperature fan sends external air into the furnace body and cools an interior of the furnace body when the monitored heating temperature is above the predetermined target temperature.

15. A charcoal grill capable of adjusting a heating temperature, comprising:
a furnace body;
a grilling grate; and
a charcoal box, comprising a charcoal box body; and at least one charcoal box cover;
wherein the grilling grate and the charcoal box are installed inside the furnace body; and
a constant temperature fan fixedly connected to an air supply port on a side of the furnace body;
wherein the at least one charcoal box cover is mounted onto the charcoal box body, the at least one charcoal box cover is rotatably connected to the charcoal box body, and a charcoal mesh is fixedly installed inside the charcoal box body;
wherein the at least one charcoal box cover is configured to be in an open state or a closed state;
wherein the open state of the at least one charcoal box cover allows for the charcoal fire to directly heat the grilling grate;
wherein the charcoal grill is configured to monitor the heating temperature and adjust settings to change the monitored heating temperature when the monitored heating temperature is outside of a predetermined target temperature; and
wherein the settings comprise open or closed states of the at least one charcoal box cover and on or off states of the constant temperature fan.

16. The charcoal grill of claim 15, comprising a rotating device, the rotating device comprising at least one rotating rod and at least one rotating motor;
wherein the at least one rotating motor is fixedly installed outside the furnace body;
wherein a first end of the at least one rotating rod passes through the furnace body and is fixedly connected to the at least one rotating motor;
wherein a second end of the at least one rotating rod is rotatably connected to the charcoal box body; and
wherein the at least one rotating rod is provided on the at least one charcoal box cover and is fixedly connected to the at least one charcoal box cover.

17. The charcoal grill of claim 15, wherein an electric heating wire is arranged at a connection between an air supply channel and the charcoal box; and wherein the electric heating wire is fixedly arranged below the charcoal mesh.

18. The charcoal grill of claim 15, wherein the furnace body comprises a furnace box body, and a furnace cover; wherein a first side of the furnace cover is rotatably connected to the furnace box body, and a second side of the furnace cover is fixedly provided with a handle; and wherein the furnace cover comprises an exhaust port.

19. The charcoal grill of claim 18, the furnace box body comprising a charcoal adding port, wherein the charcoal adding port is provided on a side wall of the furnace box body.

20. The charcoal grill of claim 15, wherein the charcoal grill is configured to open the at least one charcoal box cover when the heating temperature falls below the predetermined target temperature.
